(19) United States
(12) Patent Application Publication
(10) Pub. No.: US 2012/0268001 A1
(43) Pub. Date: Oct. 25, 2012

(54) ORGANIC LIGHT-EMITTING DISPLAY DEVICE AND METHOD OF MANUFACTURING THE SAME

(76) Inventors: Min-Woo Lee, Yongin-City (KR); Young-Mo Koo, Yongin-city (KR); Yong-Han Lee, Yongin-city (KR); Il-Hwa Hong, Yongin-city (KR)

(21) Appl. No.: 13/433,590

(22) Filed: Mar. 29, 2012

(30) Foreign Application Priority Data
Apr. 20, 2011 (KR) 10-2011-0036847

(51) Int. Cl. H05B 33/12; H05B 33/10

(52) U.S. Cl. 313/504; 445/24

(57) ABSTRACT

An organic light-emitting display device including a substrate, a first electrode formed on the substrate, a second electrode formed on the substrate separate from the first electrode, and an emissive layer interposed between the first electrode and the second electrode, wherein an auxiliary electrode is formed on the first electrode and is electrically connected to the first electrode, and the auxiliary electrode is covered by an insulating layer.

### BACKGROUND

1. Field

Embodiments relate to organic light-emitting display devices and methods of manufacturing the same.

2. Description of the Related Art

In general, an organic light-emitting display device refers to a display device including an anode, a cathode, and an organic emissive layer (EML) interposed between the anode and the cathode.

An organic light-emitting display device has wide viewing angles, high contrast, and fast response time. Depending on whether the emissive layer is formed of a polymer organic material or a low-molecular weight organic material, the organic light-emitting display device may further include at least one of a hole injection layer (HIL), a hole transport layer (HTL), an electron transport layer (ETL), and an electron injection layer (EIL). Research has recently been actively conducted on usage of organic light-emitting display devices not only as display devices but also as surface light source elements.

### SUMMARY

The embodiments may be realized by providing an organic light-emitting display device that may include a substrate, a first electrode formed on the substrate, a second electrode formed on the substrate, separate from the first electrode, and an emissive layer interposed between the first electrode and the second electrode, wherein an auxiliary electrode may be formed on the first electrode and may be electrically connected to the first electrode, and the auxiliary electrode may be covered by an insulating layer.

The first electrode may completely cover an upper surface of the substrate. The first electrode may be a transparent conductive layer. The auxiliary electrode may have a pattern including at least one opening portion, the at least one opening portion corresponding to an emission area in which the first electrode is exposed, and the emissive layer may be formed in the at least one opening portion. The emissive layer may include at least one emissive layer among emissive layers of different colors, in the at least one opening portion. The second electrode covering both the insulating layer and the emissive layer may be formed on the insulating layer which covers the auxiliary electrode and the emissive layer that is formed in the opening portion.

The first electrode may be formed to completely cover an upper surface of the substrate, and the insulating layer may be formed to cover the auxiliary electrode that is formed on the first electrode. The first electrode may be a transparent conductive layer. The auxiliary electrode may have a lattice pattern including at least one opening portion, the at least one opening portion corresponding to an emission area in which the first electrode is exposed, and the emissive layer may be formed in the at least one opening portion. The emissive layer may include at least one blue organic emissive layer among emissive layers of different colors.

The second electrode may be formed on the insulating layer and the emissive layer, the second electrode covering at least a surface of the insulating layer, and the emissive layer may be formed on the insulating layer. The auxiliary electrode may include a scattering type conductive layer. The insulating layer may include a transparent polymer.

A buffer layer may be formed between the substrate and the first electrode. The first electrode may be partitioned on the substrate into a plurality of electrode portions, an opening portion corresponding to a non-emission area may be between the partitioned electrode portions, the auxiliary electrode may be patterned on each electrode portion, and a portion corresponding to an emission area in which the first electrode is exposed may be between two positions of the patterned auxiliary electrode, and the emissive layer may be formed in an area corresponding to the emission area.

The insulating layer may include a first insulating portion covering the auxiliary electrode on the electrode portion and a second insulating portion that extends from the first insulating portion to the opening portion. Each emissive layer may include an emissive layer of a different color.

The embodiments may be realized by providing a method of manufacturing an organic light-emitting display device that may include forming a first electrode on a substrate, forming an auxiliary electrode on the first electrode (the auxiliary electrode being electrically connected to the first electrode and including opening portions through which the first electrode is exposed), forming an insulating layer covering at least a portion of the auxiliary electrode, forming an emissive layer in the opening portions, and forming a second electrode on the substrate, the second electrode being separate from the first electrode.

The first electrode may include a transparent conductive layer. Forming an auxiliary electrode may include providing a first screen mask patterned with first mask holes on the first electrode, loading a raw material on the first screen mask, and printing the raw material for forming the auxiliary electrode using a screen printing method, wherein the auxiliary electrode has a pattern including the openings through which the first electrode is exposed.

The auxiliary electrode may be formed using a scattering type conductive material. Forming an insulating layer may include providing a second screen mask patterned with second mask holes on the auxiliary electrode, loading a raw material on the second screen mask, and printing the raw material to form an insulating layer using a screen printing method, wherein the raw insulating layer may at least partially surround the auxiliary electrode. The raw material may be a transparent polymer. The first electrode may completely cover an upper surface of the substrate, and the insulating layer may cover one or more surfaces of the auxiliary electrode.

The first electrode may be partitioned into a plurality of electrode portions on the substrate, and the insulating layer may cover the auxiliary electrode and extend to an opening portion between the adjacent electrode portions, the opening portion being a non-emission area.

### BRIEF DESCRIPTION OF THE DRAWINGS

Embodiments will become more apparent by describing in detail exemplary embodiments thereof with reference to the attached drawings in which:

FIG. 1A illustrates a cross-sectional view of a substrate on which a first electrode is formed, according to an embodiment;

FIG. 1B illustrates a cross-sectional view of an auxiliary electrode being formed on the substrate of FIG. 1A;

FIG. 1C illustrates a cross-sectional view of the substrate of FIG. 1B after the auxiliary electrode is formed thereon;

FIG. 1D illustrates a cross-sectional view of an insulating layer being formed on the substrate of FIG. 1C;

FIG. 1E illustrates a cross-sectional view of the substrate of FIG. 1D after the insulating layer is formed thereon;

FIG. 1F illustrates a cross-sectional view of the substrate of FIG. 1E after an emissive layer is formed thereon;

FIG. 1G illustrates a cross-sectional view of the substrate of FIG. 1F after a second electrode is formed thereon;

FIG. 2A illustrates a plan view of the substrate of FIG. 1A after a first electrode is formed thereon;

FIG. 2B illustrates a plan view of the substrate of FIG. 2A after an auxiliary electrode is formed thereon;

FIG. 2C illustrates a plan view of the substrate of FIG. 2B after an insulating layer is formed thereon;

FIG. 3 illustrates a flowchart of a method of manufacturing an organic light-emitting display device, according to an embodiment;

FIG. 4 illustrates a cross-sectional view of an organic light-emitting display device according to another embodiment;

FIG. 5A illustrates a photographic image of an organic light-emitting display device according to an embodiment before emitting light; and

FIG. 5B illustrates a photographic image of an organic light-emitting display device according to an embodiment after emitting light.

### DETAILED DESCRIPTION

Korean Patent Application No. 10-2011-0036847, filed on Apr. 20, 2011, in the Korean Intellectual Property Office, is incorporated by reference herein in its entirety.

As the invention allows for various changes and numerous embodiments, particular embodiments will be illustrated in the drawings and described in detail in the written description. However, this is not intended to limit the embodiments to particular modes of practice, and it is to be appreciated that all changes, equivalents, and substitutes that do not depart from the spirit and technical scope of the embodiments are encompassed in the present invention. In the description of the embodiments, certain detailed explanations of related art are omitted when it is deemed that they may unnecessarily obscure the essence of the invention.

While such terms as “first,” “second,” etc., may be used to describe various components, such components must not be limited to the above terms. The above terms are used only to distinguish one component from another.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

The display module according to embodiments will be described below in more detail with reference to the accompanying drawings. Those components that are the same or are in correspondence are rendered the same reference numeral regardless of the figure number, and redundant explanations are omitted.

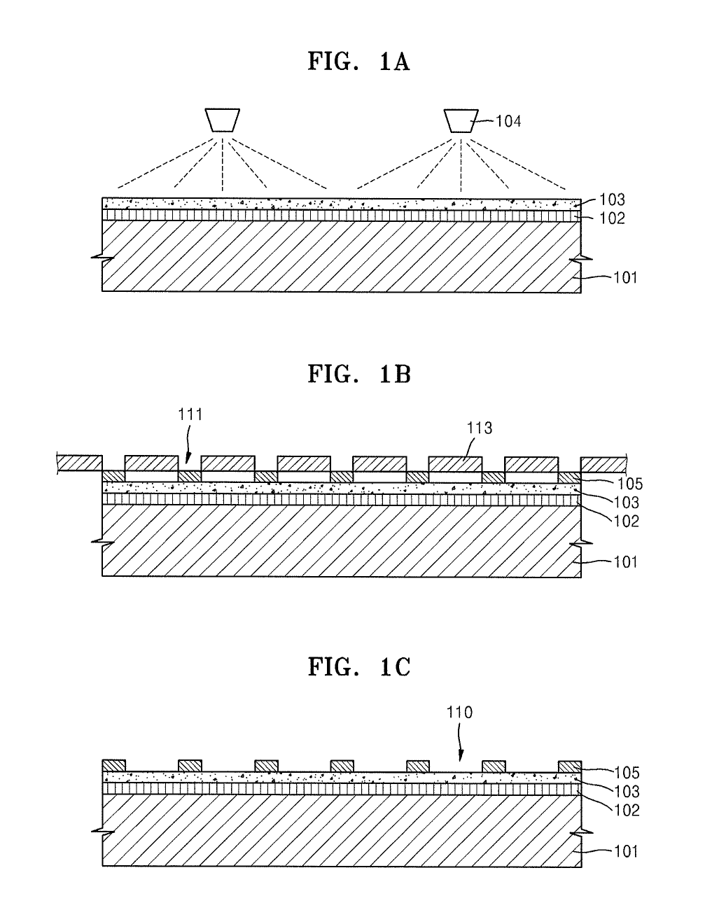

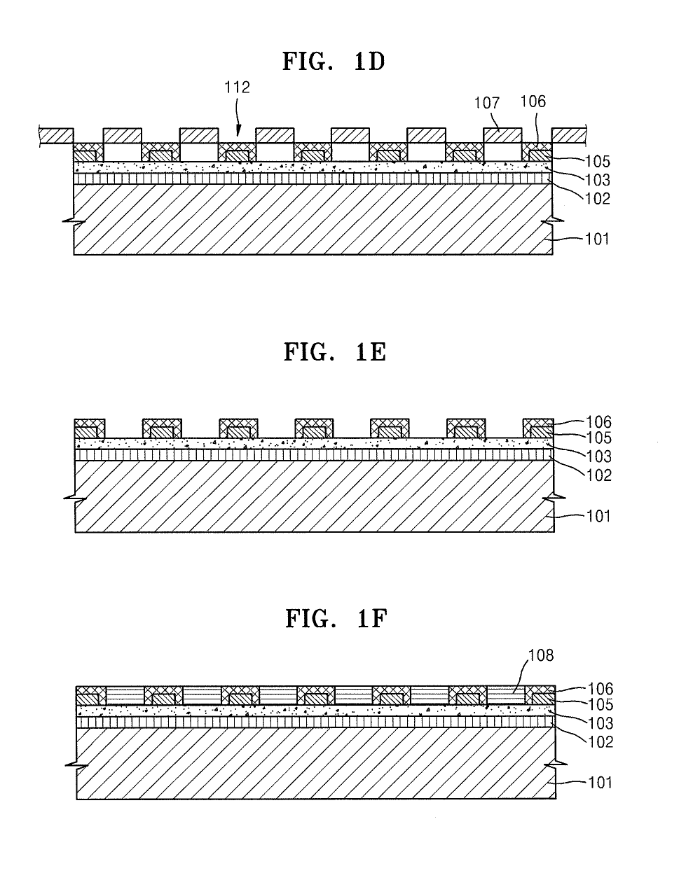

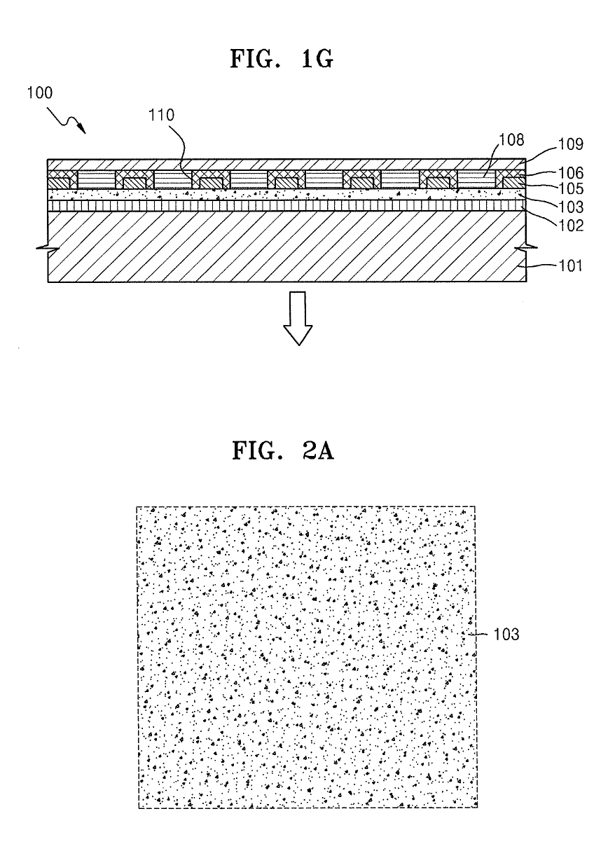

FIGS. 1A through 1G illustrate stages in a method of manufacturing an organic light-emitting display device 100, according to an embodiment.

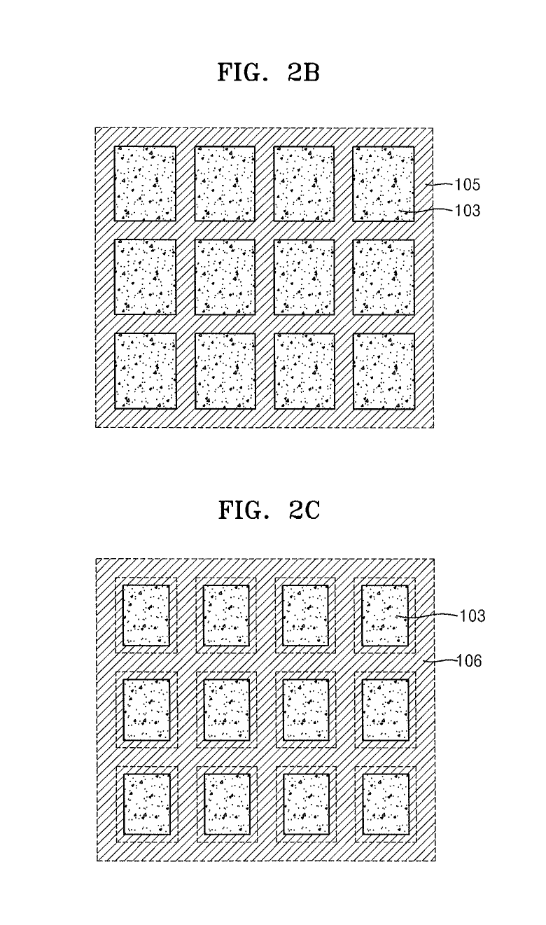

FIGS. 2A through 2C illustrate plan views of the organic light-emitting display device 100 after a first electrode 103, an auxiliary electrode 105, and an insulating layer 106 are formed therein, respectively, according to an embodiment.

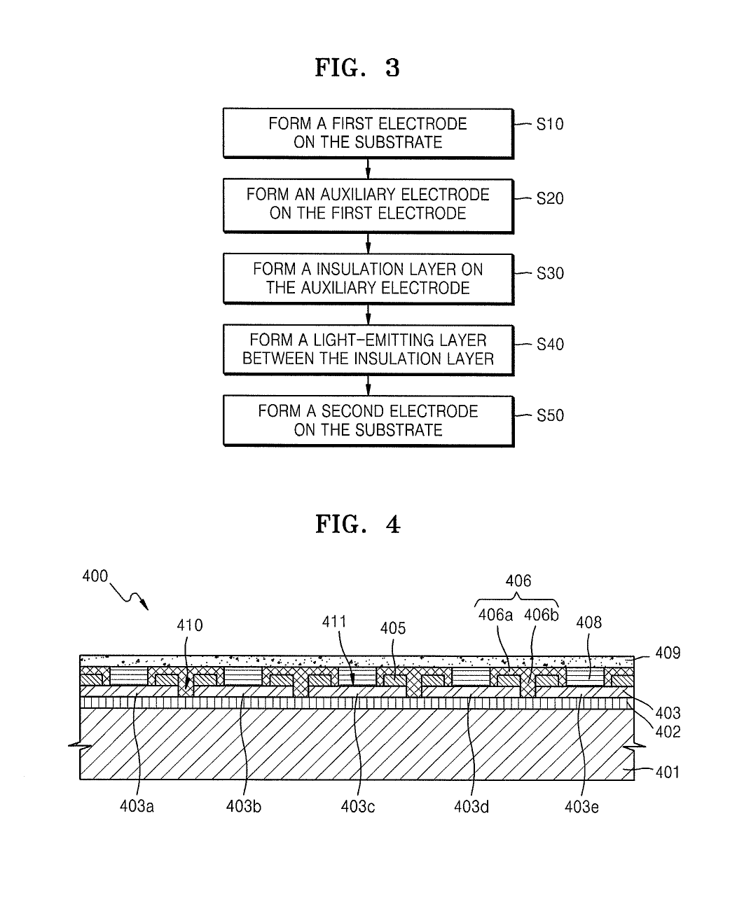

FIG. 3 illustrates a flowchart of a method of manufacturing the organic light-emitting display device 100 according to an embodiment.

Referring to FIG. 1G, the organic light-emitting display device 100 may include a substrate 101. The substrate 101 may be formed of an insulating material, for example, a glass substrate or a plastic substrate. The substrate 101 may be a transparent substrate, a semi-transparent substrate, or an opaque substrate, depending on whether an emission method used includes a front emission type or a bottom emission type.

The first electrode 103 may be formed on the substrate 101. The first electrode 103 may be an anode. The first electrode 103 may partially or completely cover an upper surface of the substrate 101.

When the organic light-emitting display device 100 is a bottom emission type, the first electrode 103 may include a transparent conductive layer having an excellent conductivity such as an indium tin oxide (ITO) film. When the organic light-emitting display device 100 is a front emission type, the first electrode 103 may include a conductive layer having a high reflectivity, such as an aluminum layer. A first electrode voltage applying unit (not shown) may be connected to at least a side of the first electrode 103, so that a positive (+) voltage may be applied to the organic light-emitting display device 100.

A buffer layer 102 may be further formed between the substrate 101 and the first electrode 103. The buffer layer 102 may provide a planar surface on the substrate 101 and prevent moisture or foreign substances from penetrating into the substrate 101. The buffer layer 102 may be formed of an insulating material such as silicon oxide (SiO2).

The auxiliary electrode 105 may be formed on the first electrode 103. The auxiliary electrode 105 may be formed to prevent a voltage drop (IR drop) of the first electrode 103 which is formed of a transparent conductive layer. The auxiliary electrode 105 may be patterned on the first electrode 103 into a particular shape.

According to a current embodiment, the auxiliary electrode 105 may be patterned to have a lattice pattern (see FIG. 2B). The lattice pattern may include a plurality of opening portions 110 through which at least a portion of the first electrode 103 is exposed.

The auxiliary electrode 105 may have any structure as long as at least a portion of the first electrode 103 is exposed. The opening portions 110 may correspond to an emission area. An aperture ratio of the organic light-emitting display device 100 when emitting light may be increased by providing as large an emission area as possible.

The auxiliary electrode 105 may include a scattering type metal layer, having an excellent conductivity, through which light can be scattered by colliding therewith. The scattering type metal layer may be an Ag paste, for example. The auxiliary electrode 105 may be patterned on the first electrode 103 at a thickness of about 2 to 4 micrometers.

The auxiliary electrode 105 may be at least partially covered by the insulating layer 106. The insulating layer 106 may include a transparent polymer, such as a transparent acrylic polymer or a transparent epoxy polymer. Use of a transparent polymer may minimize blockage of the opening portions 110.

An emissive layer 108 may be formed in the opening portions 110 corresponding to the emission area. The emissive layer 108 may include an organic emissive layer, including a low-molecular weight organic material or a polymer organic material.

For example, when a low-molecular weight organic material is used as the emissive layer 108, a hole injection layer (HIL), a hole transport layer (HTL), an electron transport layer (ETL), and an electron injection layer (EIL) may be stacked in a single or complex structure. For example, any of the HIL, HTL, ETL, and EIL, may include more than one layer. The low-molecular weight organic material may be formed by a vapor deposition method using masks or other suitable methods.

When a polymer organic material is used as the emissive layer 108, the emissive layer 108 may have a structure, including a HTL and an organic emissive layer (EML). The HTL may be formed of PEDOT; and the EML may be formed of polyphenylene vinylene (PPV) or polyfluorene polymer organic materials. The polymer organic material may be formed using a screen printing method or an inkjet printing method.

In an implementation, if white light is to be emitted by the emissive layer 108, a blue organic emissive layer may be formed as a first layer, and a mixture of a red organic emissive layer and a green organic emissive layer may be formed on the blue organic emissive layer as a second layer on the first layer. It should be understood, however, that as long as the emissive layer 108 includes an organic emissive layer, the structure of the emissive layer 108 is not limited.

A second electrode 109 may be formed on or over the substrate 101, separate from the first electrode 103. The second electrode 109 may cover the insulating layer 106 and the emissive layer 108.

The second electrode 109 may be a cathode. The second electrode 109 may be formed of a highly conductive material, for example, an aluminum film. A second electrode voltage applying unit (not shown) may be connected to a side of the second electrode 109 to thereby apply a negative (−) voltage to the organic light-emitting display device 100.

When power is supplied to the first electrode 103 and the second electrode 109 of the organic light-emitting display device 100 having the above-described configuration, organic molecules of the emissive layer 108 may be excited and excitons may be generated. While the excitons may be emitted and inactivated, light may be emitted through a lower portion of the substrate 101, as indicated by an arrow in FIG. 1G. The organic light-emitting display device 100, according to an embodiment, may be a bottom emission type display device.

Light emitted toward an upper portion of the substrate 101 may be reflected by the second electrode 109 having reflectivity, and may be emitted through the lower portion of the substrate 101. Also, light emitted toward the insulating layer 106 may be transmitted through the insulating layer 106 since the insulating layer 106 is transparent. The transmitted light may be scattered by the auxiliary electrode 105, which has scatterability. Accordingly, the auxiliary electrode 105 may emit light by itself.

Hereinafter, the method of manufacturing the organic light-emitting display device 100 having the above-described configuration will be described in order.

As illustrated in FIG. 1A, the buffer layer 102 may be formed on the substrate 101. The buffer layer 102 may be formed using an insulating material such as a silicon oxide (SiO2). The first electrode 103 may be formed on an upper surface of the buffer layer 102. The first electrode 103 may be formed as a transparent conductive layer such as an ITO layer. The first electrode 103 may be formed to completely cover an upper surface of the substrate 101. The first electrode 103 may be formed using a vacuum deposition method, a sputtering method, or the like. The first electrode 103 may be an anode (see FIG. 2A and operation S10 of FIG. 3).

The first electrode 103 may be cleansed using a nozzle portion 104. After annealing the first electrode 103, a first screen mask 113, patterned with first mask pattern holes 111, may be disposed on an upper surface of the first electrode 103, as illustrated in FIG. 1B. The shape of the first mask pattern holes 111 may correspond to the shape of the auxiliary electrode 105 that is to be patterned.

A raw material for a scattering type auxiliary electrode, for example, an Ag paste, may be loaded on the first screen mask 113 and printed using a screen printing method. Accordingly, the auxiliary electrode 105 on the upper surface of the first electrode 103 is patterned. A thickness of the auxiliary electrode 105 is from about 2 to about 4 micrometers.

After the auxiliary electrode 105 is patterned, the auxiliary electrode 105 may be annealed for activation, as illustrated in FIG. 1C. Accordingly, the auxiliary electrode 105, on the upper surface of the first electrode 103, may be completely formed.

The auxiliary electrode 105 may have a lattice pattern so that a portion of the first electrode 103 may be exposed through opening portions 110. The opening portions 110 may correspond to an emission area (see FIG. 2B and operation S20 of FIG. 3).

Next, as illustrated in FIG. 1D, a second screen mask 107, patterned with second mask pattern holes 112 may be disposed on the substrate 101. The shape of the second mask pattern holes 112 may correspond to the shape of the insulating layer 106 to be patterned.

A transparent polymer such as a transparent acrylic polymer or a transparent epoxy polymer material may be loaded on the second screen mask 107 and printed using a screen printing method.

After the insulating layer 106 is patterned, the insulating layer 106 may be annealed as illustrated in FIG. 1E. Consequently, the auxiliary electrode 105 patterned on the first electrode 103 may be completely covered by the insulating layer 106 (see FIG. 2C and operation S30 of FIG. 3).

Next, as illustrated in FIG. 1F, the emissive layer 108 may be formed in the opening portions 110 through which a portion of the first electrode 103 is exposed. The emissive layer 108 may include an organic EML. The emissive layer 108 may selectively include a HIL, a HTL, an ETL, and an EIL.

In addition, if monochromic color light, for example, white light, is to be emitted through the emissive layer 108, a blue emissive layer may be first formed, and a mixture of a red emissive layer and a green emissive layer may be formed thereon (see operation S40 of FIG. 3).

Next, as illustrated in FIG. 1G, the second electrode 109, which covers the insulating layer 106 and the emissive layer 108, may be formed on the insulating layer 106 and the emissive layer 108. The second electrode 109 may be a cathode (see operation S50 of FIG. 3).

As described above, the auxiliary electrode 105, formed of a scattering type conductive layer, and the insulating layer 106, formed of a transparent polymer may be formed using a screen printing method. The manufacturing method of the organic light-emitting display device 100 may, thereby, be simplified.

FIG. 4 illustrates an organic light-emitting display device 400 according to another embodiment.

Referring to FIG. 4, the organic light-emitting display device 400 may include a substrate 401. A buffer layer 402 may be formed on the substrate 401. A first electrode 403 may be formed on the buffer layer 402. The first electrode 403 may include a transparent conductive layer such as an ITO layer. The first electrode 403 may be patterned such that a plurality of electrode portions 403a through 403e are partitioned on the substrate 401. Opening portions 410 may be formed in spaces between the plurality of partitioned electrode portions 403a through 403e. The opening portions 410 may correspond to a non-emission area.

An auxiliary electrode 405 may be patterned on the plurality of electrode portions 403a through 403e. The auxiliary electrode 405 may be formed on each of the electrode portions 403a through 403e such that portions 411 of the electrode portions 403a through 403e are exposed. The portions 411 may correspond to an emission area.

The emission area, through which a portion of the first electrode 403 is exposed, may be configured to be as large as possible so as to increase an aperture ratio. The auxiliary electrode 405 may be formed of a highly conductive, scattering type metal layer, such as an Ag paste. Thus, light may be scattered to thereby increase a light-emitting efficiency of the organic light-emitting display device 400.

The auxiliary electrode 405 may be covered by an insulating layer 406. The insulating layer 406 may be a pattern on the plurality of electrode portions 403a through 403e so as to cover the auxiliary electrode 405. Also, the insulating layer 406 may be formed in the opening portions 410, corresponding to the non-emission area.

To this end, the insulating layer 406 may include a first insulating portion 406a that covers the auxiliary electrode 105 on the plurality of electrode portions 403a through 403e and a second insulating layer 406b that extends from the first insulating portion 406a into the opening portions 410. The first insulating portion 406a and the second insulating portion 406b may be integrally formed, for convenience of manufacture.

An emissive layer 408 may be formed in the emission area in which the portions 411 of the plurality of electrode portions 403a through 403e are exposed. When the organic light-emitting display device 400 is used as a display device, each emissive layer 408 may selectively include different organic emissive layers. For example, a red organic emissive layer, a green organic emissive layer, and a blue organic emissive layer may be selectively included in each emissive layer 408.

A second electrode 409 may be formed on the substrate 401, separately from the first electrode 403. The second electrode 409 may be formed both on the insulating layer 406 and the emissive layer 408.

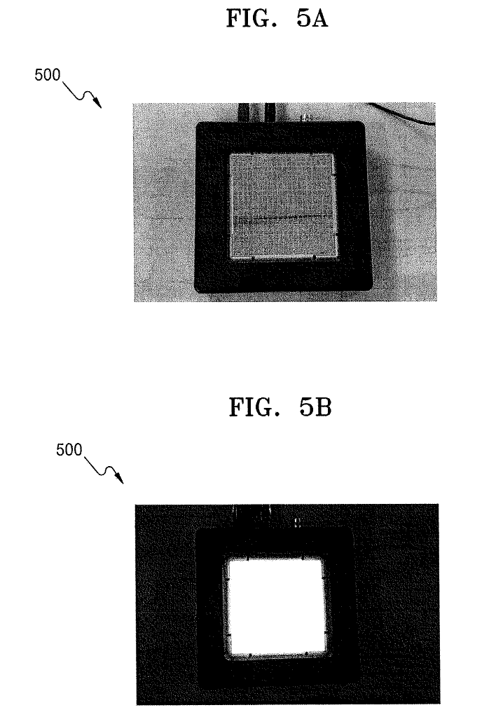

FIG. 5A illustrates a photographic image of an organic light-emitting display device 500 according to an embodiment, before emitting light. FIG. 5B illustrates a photographic image of the organic light-emitting display device 500 when emitting light.

Referring to FIGS. 5A and 5B, the organic light-emitting display device 500 may include a scattering type auxiliary electrode and a transparent insulating layer surrounding the scattering type auxiliary electrode. Thus, light may be uniformly emitted from all areas of the organic light-emitting display device 500. For example, an aperture ratio of the organic light-emitting display device 500 may be improved. Loss of light may be minimized to thereby increase a light-emitting efficiency of the organic light-emitting display device 500.

As described above, using the scattering type auxiliary electrode in the organic light-emitting display device and the method of manufacturing the organic light-emitting display device, may minimize loss of light.

In addition, use of a transparent insulating layer may increase an aperture ratio of an emissive layer. Embodiments provide organic light-emitting display devices including an emissive layer having an improved aperture ratio to thereby increase a light-emitting efficiency of the organic light-emitting display devices, and methods of manufacturing the organic light-emitting display devices.

Also, use of a screen printing method may simplify the manufacturing process of the organic light-emitting display device.

While embodiments have been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An organic light-emitting display device, comprising:
a substrate;
a first electrode formed on the substrate;
a second electrode formed on the substrate, separate from the first electrode; and
an emissive layer interposed between the first electrode and the second electrode,
wherein an auxiliary electrode is formed on the first electrode and is electrically connected to the first electrode, and the auxiliary electrode is covered by an insulating layer.

2. The organic light-emitting display device of claim 1, wherein the first electrode completely covers an upper surface of the substrate.

3. The organic light-emitting display device of claim 2, wherein the first electrode is a transparent conductive layer.

4. The organic light-emitting display device of claim 1, wherein:
the auxiliary electrode has a pattern including at least one opening portion, the at least one opening portion corresponding to an emission area in which the first electrode is exposed, and
the emissive layer is formed in the at least one opening portion.

5. The organic light-emitting display device of claim 4, wherein the emissive layer comprises at least one emissive layer among emissive layers of different colors, in the at least one opening portion.

6. The organic light-emitting display device of claim 4, wherein the second electrode covering both the insulating layer and the emissive layer is formed on the insulating layer which covers the auxiliary electrode and the emissive layer that is formed in the opening portion.

7. The organic light-emitting display device of claim 1, wherein the auxiliary electrode includes a scattering type conductive layer.

8. The organic light-emitting display device of claim 1, wherein the insulating layer includes a transparent polymer.

9. The organic light-emitting display device of claim 1, further comprising a buffer layer formed between the substrate and the first electrode.

10. The organic light-emitting display device of claim 1, wherein:
the first electrode is partitioned on the substrate into a plurality of electrode portions,
an opening portion corresponding to a non-emission area is between the partitioned electrode portions,
the auxiliary electrode is patterned on each electrode portion,
a portion corresponding to an emission area in which the first electrode is exposed is between two positions of the patterned auxiliary electrode, and
the emissive layer is formed in an area corresponding to the emission area.

11. The organic light-emitting display device of claim 10, wherein the insulating layer comprises a first insulating portion covering the auxiliary electrode on the electrode portion and a second insulating portion that extends from the first insulating portion to the opening portion.

12. The organic light-emitting display device of claim 10, wherein each emissive layer includes an emissive layer of a different color.

13. A method of manufacturing an organic light-emitting display device, the method comprising:
forming a first electrode on a substrate;
forming an auxiliary electrode on the first electrode,
the auxiliary electrode being electrically connected to the first electrode and including opening portions through which the first electrode is exposed;
forming an insulating layer covering at least a portion of the auxiliary electrode;
forming an emissive layer in the opening portions; and
forming a second electrode on the substrate, the second electrode being separate from the first electrode.

14. The method of claim 13, wherein the first electrode includes a transparent conductive layer.

15. The method of claim 13, wherein forming an auxiliary electrode includes:
providing a first screen mask patterned with first mask holes on the first electrode;
loading a raw material on the first screen mask; and
printing the raw material for forming the auxiliary electrode using a screen printing method,
wherein the auxiliary electrode has a pattern including the openings through which the first electrode is exposed.

16. The method of claim 15, wherein the auxiliary electrode is formed using a scattering type conductive material.

17. The method of claim 13, wherein forming an insulating layer includes:
providing a second screen mask patterned with second mask holes on the auxiliary electrode;
loading a raw material on the second screen mask; and
printing the raw material to form an insulating layer using a screen printing method,
wherein the raw insulating layer at least partially surrounds the auxiliary electrode.

18. The method of claim 17, wherein the raw material is a transparent polymer.

19. The method of claim 13, wherein:
the first electrode is formed to completely cover an upper surface of the substrate, and
the insulating layer is formed to cover the auxiliary electrode that is formed on the first electrode.

20. The method of claim 13 wherein:
the first electrode is partitioned into a plurality of electrode portions on the substrate, and
the insulating layer covers the auxiliary electrode and extends to an opening portion between the adjacent electrode portions, the opening portion being a non-emission area.
